(19) United States
(12) Patent Application Publication
(10) Pub. No.: US 2008/0017301 A1
(43) Pub. Date: Jan. 24, 2008

(54) TRANSFER FILMS FOR GRAPHIC SUBSTRATES

(75) Inventors: Jeffrey O. Emslander, Afton, MN (US); Frank T. Sher, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/427,551

(22) Filed: Jun. 29, 2006

(51) Int. Cl. B44C 1/17; B05D 5/00; B05D 3/02; B32B 38/14; B32B 37/04

(52) U.S. Cl. 156/240; 427/256; 427/372.2; 156/277; 156/308.2; 156/239

(57) ABSTRACT

A method of making an image transfer film article and a method of protecting graphic substrates are disclosed. One method of making an image transfer film article includes printing an image onto a transparent thermoplastic protective layer, where the image is formed by an ink-jet printer and an organic solvent-based ink including an organic solvent, a thermoplastic material, and a pigment; and then drying off at least a portion of the organic solvent to form the image transfer film article.

### BACKGROUND

The present disclosure relates generally to transfer films for graphic substrates, and particularly to protective films that have been printed with organic solvent-based inks and that can be applied to graphic substrates.

Unlike the image produced by conventional printing, an ink jet image is transferred to the image receptor without a great deal of force. Ink droplets are emitted from a nozzle and deposited on a receptor to form an image. The ink should be absorbed into the receptor in order to form high quality images and avoid excessive ink spreading across the receptor.

Coating an organic solvent-based ink onto a graphic film is difficult since the organic solvent in the ink tends to solvate a portion of the graphic film, which can have a negative effect on the physical properties of the graphic film. The organic solvent in the ink can also have a negative effect on the physical properties of any adhesive disposed on the graphic film.

Graphics intended for exterior display are frequently protected with a coating or film to shield the graphics from environmental damage, such as fading from exposure to ultraviolet light, delamination caused by moisture or humidity, scratching resulting from airborne particles, yellowing caused by pollutants, vandalism, etc. Clear coating has been found to increase the useful life span of graphics and is widely used in the industry. Such protective coatings, commonly referenced as “clear coats”, can be applied by flood coating the finished graphics with a solvent-based solution of the clear coat polymer with evaporation of the solvent. However, solvent-based methods of applying a clear coat suffer several major drawbacks including significant time delays in the manufacture of graphics caused by the need to remove solvent from the clear coat solution and the absorption of solvents into the graphic film.

### SUMMARY

In one exemplary implementation, the present disclosure is directed to a method of making an image transfer film article by printing an image onto a transparent thermoplastic protective layer, where the image is formed by an ink-jet printer and an organic solvent-based ink including an organic solvent, a thermoplastic material, and a pigment; and then drying off at least a portion of the organic solvent to form the image transfer film article.

In another exemplary implementation, the present disclosure is directed to a method of protecting a graphic substrate including providing a transparent thermoplastic protective layer, printing an image onto the transparent thermoplastic protective layer, where the image is formed by an ink-jet printer and an organic solvent-based ink including an organic solvent, a thermoplastic material, and a pigment, drying off at least a portion of the organic solvent to form the image transfer film article, and then laminating the image transfer film article onto a graphic substrate with heat and pressure. Both the transparent thermoplastic protective layer and the thermoplastic material soften and adhere to the graphic substrate to form a protected graphic substrate.

These and other aspects of the transfer hardcoat film articles according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, in which:

FIG. 1 is a schematic diagram of a transparent image transfer film article; and

FIG. 2 is a schematic diagram of a protected graphic substrate.

### DETAILED DESCRIPTION

Accordingly, the present disclosure is directed to organic solvent-based ink printed transfer films for graphic substrates, and particularly to organic solvent-based ink printed transfer films that can be applied to graphic substrates. While the present invention is not so limited, an appreciation of various aspects of the invention will be gained through a discussion of the examples provided below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “polymer” will be understood to include polymers, copolymers (e.g., polymers formed using two or more different monomers), oligomers and combinations thereof, as well as polymers, oligomers, or copolymers that can be formed in a miscible blend.

The term “transparent film” refers to a film having a thickness and when the film is disposed on a substrate, an image (disposed on or adjacent to the substrate) is visible through the thickness of the transparent film. In many embodiments, a transparent film allows the image to be seen through the thickness of the film without substantial loss of image clarity. In some embodiments, the transparent film has a matte or glossy finish.

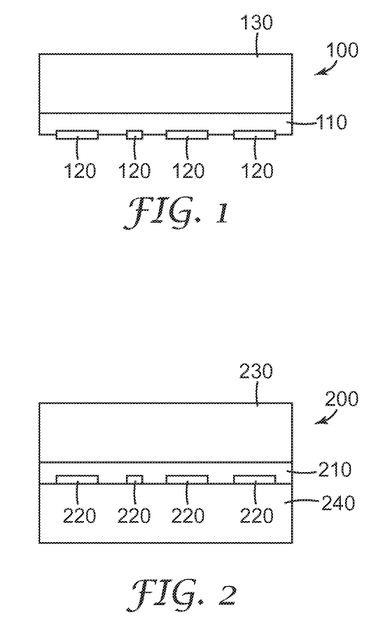

FIG. 1 shows a schematic diagram of one exemplary embodiment of a transparent image transfer film article 100. The illustrated transparent image transfer film article 100 includes a transparent thermoplastic protective layer 110 disposed on a release liner 130. In many embodiments, the transparent thermoplastic protective layer 110 includes an ink receptor layer. In other embodiments, the transparent thermoplastic protective layer 110 is an ink receptor layer.

The image 120 is formed on the transparent protective layer/ink receptive layer 110 with a solvent-based ink jet printing process. Solvent-based ink jet printing processes allow for the image 120 to be formed of a thermoplastic material, described below. The ink jet ink includes an organic solvent, a thermoplastic material, and a pigment. The organic solvents can include any organic solvents or organic solvent blends useful for solubilizing the thermoplastic ink material and includes, for example, ketones, glycol ethers, esters, and the like. The pigment can include any pigment useful for providing color to the ink and are known in the ink jet field. The thermoplastic materials in the ink are described below.

In many embodiments, the image 120 is reverse printed on the transparent protective layer/ink receptive layer 110 so that when the printed transparent protective layer/ink receptive layer 110 is laminated to a graphic substrate (described below) the image 120 appears through the transparent protective layer/ink receptive layer 110 in the proper orientation.

The transparent thermoplastic protective layer 110 can include a transparent thermoplastic polymer such as, for example a transparent polyacrylate, polyurethane, and/or polyacrylate polyurethane co-polymer or blend. Examples of these suitable thermoplastic polymers include, but are not limited to, a urethane polymer, an acrylate polymer, a vinyl polymer, or mixtures thereof. Specific polymers include, but are not limited to, acrylic copolymers or homopolymers containing materials, such as, methyl methacrylate, ethyl methacrylate, butyl methacrylate, ethylene methacrylic acid, ethylene acrylic acid, acrylic acid, ethyl acrylate, methyl acrylate, butyl acrylate, iso-octyl acrylate, 2-ethylhexyl acrylate; polyurethane polymers and copolymers; vinyl copolymers such as vinyl chloride/vinyl acetate copolymers; urethane/acrylate copolymers. In one embodiment the thermoplastic polymer includes an acrylate/urethane copolymer or blend. The thickness of the transparent thermoplastic protective layer 110 can be any useful thickness. In some embodiments, the transparent thermoplastic protective layer 110 has a thickness of 10 to 100 micrometers or 25 to 50 micrometers.

In many embodiments, the transparent thermoplastic protective layer 110 can include an ink receptive material. An ink receptive material is a material that is receptive to organic solvent-based ink jet ink. “Organic solvent-based” means a non-aqueous solvent. The transparent thermoplastic protective layer can include a blend of a thermoplastic polymer as described above and an ink absorptive resin.

The ink receptive material is derived from and thus comprises certain urethane-containing polymeric resins. As used herein “base polymer” refers to a single urethane-containing copolymer such as a urethane acrylic copolymer optionally blended with a polyurethane polymer or an acrylic polymer, a blend of at least one polyurethane polymer and at least one acrylic polymer, a blend of at least two polyurethane polymers, and mixtures thereof. Further, the urethane-containing base polymer may optionally be crosslinked. The blend of polymers may form a homogeneous mixture or may be multiphase, exhibiting two or more distinct peaks when analyzed via differential scanning calorimetry (DSC). Further, the ink receptive composition may comprise an interpenetrating network of the base polymer in an insoluble matrix or vice-versa.

To achieve good image quality during ink jet printing the printed ink drops spread to within an acceptable range in order to provide the desired image. The use of an acrylic polymer alone as an ink receptive layer tends to result in the ink drops not spreading enough leaving smaller than desired ink drops that contribute to reduced color density and banding defects (i.e. gaps between the rows of ink drops). This is surmised to be due to the good solvent uptake of acrylic polymers. On the other hand, the use of a polyurethane polymer alone tends to result in the ink drops spreading too much, resulting in loss of resolution, poor edge acuity, and inter-color bleed occurs in the case of multi-color graphics. This is surmised to be due to insufficient solvent uptake of polyurethane polymers. The ink receptive material described herein exhibits a good balance of ink uptake and color density even though the composition is substantially free of fillers as well as the composition being substantially free of components that are soluble in the solvent of the ink.

The ink receptive coating layer is initially swelled after application of the ink jetted ink. However, after drying (i.e. evaporation of the solvent) the thickness of the ink receptive material is substantially the same as prior to ink application. Although the ink receptive material absorbs the solvent portion of the ink, the binder and colorant of the ink composition tend to remain on the surface of the ink receptive material. Accordingly, at least the urethane portion of the ink receptive coating layer is substantially insoluble in the ink composition (e.g. solvent of the ink).

The ink receptive material includes a urethane containing copolymer. As used herein “copolymer” refers to a polymer having urethane segments and segments of at least one polymeric material that is different than a urethane. In many embodiments, urethane acrylic copolymers include those commercially available from Neoresins Inc., Wilmington, Mass., such as under the trade designation “NeoPac R-9000”. The urethane acrylic copolymer may be employed alone or optionally in combination with at least one polyurethane polymer or at least one acrylic polymer. For use on polyolefin films, it is preferred to employ the NeoPac R-9000 alone or blended with an acrylic resin such as “NeoCryl A-612” at a ratio of about 4:1.

In some embodiments, the ink receptive coatings are preferably derived from a blend comprising at least two polyurethane polymers or at least one polyurethane polymer and at least one acrylic polymer. Aliphatic polyurethanes typically exhibit greater durability, resistance to yellowing, etc. and thus are preferred. Illustrative examples of useful aqueous polyurethane dispersions include those commercially available from Neoresins, Wilmington, Mass. under the trade designations “NeoRez R-960”, “NeoRez R-966”, “NeoRez R-9637”, “NeoRez R-600”, “NeoRez R-650”, “NeoRez R-989” and “NeoRez R-9679”.

The concentration of polyurethane in the ink receptive material generally ranges from about 40 wt-% to about 100 wt-% solids, i.e. the weight of the polyurethane after evaporation of water and/or solvent of the polyurethane emulsion or dispersion relative to the content of the other solid materials in the formulation. Preferably, the amount of polyurethane in the polyurethane/acrylic blend is at least about 50 wt-% and more preferably at least about 60 wt-%.

In other embodiments, ink receptive coatings further include at least one acrylic polymer, the amount of acrylic polymer generally ranges from about 10 wt-% to about 60 wt-% solids. Various acrylic resins are known. A particularly suitable water-based acrylic emulsion is commercially available from Neoresins, Wilmington Mass. under the trade designations “NeoCryl A-612” (reported to have a Konig Hardness of 75 at 144 hours).

Preferred blends comprising a polyurethane polymer and an acrylic polymer include mixtures of NeoRez R-960 and/or NeoRez R-966 (Sward Hardness=30) with Neocryl A-612 (acrylic) wherein the proportion of polyurethane to acrylic is about 2:1. NeoRez R-9679 is also suitable in place of NeoRez R-960 at slightly lower concentrations of polyurethane (e.g. weight ratio of 55/45). The blends just described are particularly preferred for films used as graphic substrates. Another preferred composition, particularly for embodiments wherein the composition is coated onto a polyolefin-containing film includes NeoRez R-600 and NeoCryl A-612 at a ratio of 4:1.

In one embodiment, ink receptive materials include a blend of at least two polyurethane polymers include a mixture of NeoRez R-650 and NeoRez R-989 at a ratio of 9:1. The NeoRez R989 is available from NeoResins in Japan.

The base polymer of the ink receptive material has a solubility parameter, molecular weight, and glass transition temperature (Tg) within a specified range. As used herein, “molecular weight” refers to weight average molecular weight (Mw), unless specified otherwise. In many embodiments, the base polymer and the transparent thermoplastic polymer are formed of the same material and can be the same material.

The solubility parameter of the base polymer of the ink receptive material as well as the ink composition ink jetted onto the coated substrate may vary, typically ranging from about 7 (cal/cm³)^{1/2} to about 12 (cal/cm³)^{1/2}. In some embodiments, the solubility parameter of both the ink and ink receptive material is at least about 8 (cal/cm³)^{1/2} and less than about 10 (cal/cm³)^{1/2}. The solubility of various pure materials, such as solvents, polymers, and copolymers as well as mixtures is known. The solubility parameters of such materials are published in various articles and textbooks. In the present invention, the terminology “solubility parameter” refers to the Hildebrand solubility parameter which is a solubility parameter represented by the square root of the cohesive energy density of a material.

The base polymer has a weight average molecular weight (Mw) as measured by Gel Permeation Chromotography (GPC) of greater than about 60,000 g/mole, or greater than about 80,000 g/mole, or greater than about 100,000 g/mole. Water-borne polymeric materials as well as aqueous dispersions and emulsions often contain polymeric materials having a relatively high Mw, ranging from greater than 400,000 to 1,000,000 or more.

In addition to the previously described solubility parameter and Mw, the base polymer of the ink receptive material ranges in glass transition temperature (Tg), as measured according to Differential Scanning Colorimetry (DSC) from about 30 degrees centigrade to about 95 degree centigrade or from about 50 degrees centigrade to about 80 degrees centigrade. Although the polyurethane alone may have a Tg of less than about 30 degrees centigrade, the presence of the higher Tg acrylic polymer ensures that the Tg of the blend is within the specified range. At a Tg of greater than about 95 degrees centigrade, the solvent of the ink generally does not significantly penetrate into the ink receptive material. These ink receptive materials are disclosed in U.S. Pat. No. 6,881,458 and is incorporated by reference herein, to the extent it does not conflict.

To enhance durability of the transparent thermoplastic protective layer, especially in outdoor environments exposed to sunlight, a variety of commercially available stabilizing chemicals can be added. These stabilizers can be grouped into the following categories: heat stabilizers, ultraviolet (UV) light stabilizers, and free-radical scavengers. Heat stabilizers are commonly used to protect the resulting image graphic against the effects of heat and are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. Such heat stabilizers can be present in amounts ranging from 0.02 to 0.15 weight percent. UV light stabilizers can be present in amounts ranging from 0.1 to 5 weight percent of the total ink composition. Benzophenone type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581”. In general, the transparent thermoplastic protective layer can be substantially free of colorant until it is printed with an image. However, it may also contain colorants to provide a uniform background colored film.

The release liner 130 can be formed of any useful material such as, for example, polymers or paper and may include a release coat. Suitable materials for use in release coats are well known and include, but are not limited to, fluoropolymers, acrylics and silicones designed to facilitate the release of the release liner from the transparent thermoplastic protective layer 110.

The release liner 130 can provide rigidity to the transparent thermoplastic protective layer 110. Such an increased rigidity can facilitate transportation, storage, and handling of the transparent thermoplastic protective layer 110. The release liner 130 can be a single layer, or multi-layered, and can include a polyethylene terephthalate (PET) film, a paper-coated polyethylene, a thermoplastic film with a releasable surface, either by the nature of the thermoplastic used or by applying a conventional release coating, polypropylene, polyethylene provided the adhesive bond strength between the interface of the release liner 130 and the transparent thermoplastic protective layer 110 permits handling up to the point of final application, but permits release once the final product is installed. Additionally, the release liner 130 protects the surface of an imaged transfer film from abrasion and damage during application, that is, installation.

The image transfer film article described above can be used to protect a graphic and a graphic substrate by laminating the image transfer film article onto a graphic substrate with heat and pressure. The transparent thermoplastic protective layer and the image (formed of a thermoplastic material) soften with the application of heat and adhere to the graphic substrate to form a protected graphic substrate. Then, removal of the release liner 130 produces the final protected graphic substrate.

FIG. 2 illustrates one embodiment of a protected graphic substrate 200. As described above, the transparent image transfer film article includes a transparent thermoplastic protective layer 210 disposed on a release liner 230. In many embodiments, the transparent thermoplastic protective layer 210 includes an ink receptor layer. In other embodiments, the transparent thermoplastic protective layer 210 is an ink receptor layer. The transparent thermoplastic protective layer 210 is adhered to a graphic substrate 240.

The graphic substrate 240 can be formed from any suitable graphic substrate material. In many embodiments, the graphic substrate 240 is a conformable material such as a polymer film, for example a polyolefin, polyester, polyamide, and/or polycarbonate film. In some embodiments, the graphic substrate 240 is a vinyl film such as, for example, a polyvinyl chloride (PVC) film. In other embodiments, the graphic substrate 240 is rigid polymeric or rigid non-polymeric substrate or film. In some embodiments, the graphic substrate 240 includes an image disposed on or in the graphic substrate 240. In some embodiments, the graphic substrate 240 may contain colorants to provide a uniform background colored film.

The image 220 is printed onto the transparent thermoplastic protective layer 210 via organic solvent based ink jet printing (as described above). In many embodiments, the ink jet ink includes an organic solvent, a thermoplastic material and a pigment. Prior to the lamination step, at least a portion of the organic solvent is dried off the printed image.

The thermoplastic material in the ink, that forms the image 220, can be any thermoplastic useful material listed above. In many embodiments, the thermoplastic material and the transparent thermoplastic protective layer include the same polymer type.

The transparent image transfer film article can be laminated onto the graphic substrate 240 with heat and pressure sufficient to soften the transparent thermoplastic protective layer 210 and the image 220. The softened transparent thermoplastic protective layer 210 and the thermoplastic image 220 then adhere or bond to the graphic substrate 240. The release liner is then removed to finish the graphic fabrication process. In some cases the release liner is not removed until the total graphic substrate is applied to the desired display—in this embodiment, the release liner may act as a protective premask tape during installation.

In many embodiments, an adhesive such as, for example, a pressure sensitive adhesive can be disposed on the graphic substrate 240 for application to a display substrate. Illustrative display substrates includes for example, building surfaces, vehicle surfaces or other graphic display surfaces. Another release layer can be disposed on the pressure sensitive adhesive to protect the pressure sensitive adhesive during transport and handling.

The articles and methods described herein provide many advantages over current technology. For example, thermoplastic graphics can be laminated onto substrates that are generally sensitive to organic solvents because the organic solvent has been substantially removed from the thermoplastic graphic via drying prior to application and lamination to substrates such as, PVC films. These articles and methods, allow these substrates or films to retain their physical properties and reduce solvent odor and film curl, to list a few.

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

### EXAMPLES

### Example 1

A 12 inch (30 cm)×12 inch (30 cm) PET film (i.e., release liner) was coated with an ink receptive composition of a 50/50 blend of DSM Avecia NeoCryl A-612 acrylic dispersion (DSM NeoResins, Waalwijk, The Netherlands)/Avecia NeoRez R960 (DSM NeoResins) urethane dispersion using a knife coater set to a gap of 0.004 inches (100 micrometers). The ink receptor coated film was dried in a forced air oven set to 150 degrees F. (65 degrees C.) for 10 minutes. The ink receptor coating on the PET film was reverse printed with a test photographic image applied to about a 10 inch (25 cm)×10 inch (25 cm) area on the ink receptor coated film. The image was printed with a Gerber Orion printer (Gerber Scientific. South Windsor, Conn., USA) using 3M 3700 Series inks (3M Company, St. Paul, Minn., USA) using 75% ink laydown. After printing, the image was air dried overnight (approximately 16 hours).

The printed ink receptor layer of the ink receptor coated film was heat laminated to 3M™ Controltac™ Plus Graphic Film Series 180-10 (50 micrometer thick white vinyl film; “180 Vinyl Film”; 3M Company) using a Pro-Tech Model EGS-692 laminator (GBC Pro-Tech, Addison, Wis., USA) at 2 feet per minute (0.72 meters/minute), 65 psig (450 kPa) and 200 F. degrees (93 degrees C.). Upon cooling, the PET release liner was removed from the construction resulting in a very smooth, high gloss surface with no solvent odor detectable.

### Example 2

A 12 inch (30 cm)×12 inch (30 cm) PET film (I.e., release liner) was coated with an ink receptive composition of Stahl #WF-55-034 (Stahl USA, Peabody, Mass., USA) polyurethane dispersion using a knife coater set to a gap of 0.004 inches (100 micrometers). The ink receptor coating was dried in a forced air oven set to 160 degrees F. (71 degrees C.) for 10 minutes. The ink receptor coating on the PET film was reverse printed with a test photographic image applied to about a 10 inch (25 cm)×10 inch (25 cm) area on the coated ink receptor film. The image was printed with a Vutek 2360 printer (Vutek, Meredith, N.H., USA) using 3M 1500 Series inks (3M Company). After printing the image was air dried overnight (approximately 16 hours).

The printed ink receptor layer of the ink receptor coated film was heat laminated to 180 Vinyl Film using the Pro-Tech laminator, described in Example 1, at 3 feet per minute (0.91 meters/minute), 65 psig (450 kPa) and 250 degrees F. (121 degrees C.). Upon cooling the PET release liner was removed from the construction resulting in a very smooth, high gloss surface with no solvent odor detectable.

We claim:

1. A method of making an image transfer film article comprising:
printing an image onto a transparent thermoplastic protective layer, wherein the image is formed by an ink-jet printer and an organic solvent-based ink comprising organic solvent, a thermoplastic material, and a pigment; and
drying off at least a portion of the organic solvent to form the image transfer film article.

2. A method according to claim 1 wherein the thermoplastic material comprises a urethane polymer, an acrylate polymer, a vinyl polymer, or mixtures thereof.

3. A method according to claim 1 wherein the transparent thermoplastic protective layer comprises a urethane polymer, an acrylate polymer, a vinyl polymer, or mixtures thereof.

4. A method according to claim 1 wherein the transparent thermoplastic protective layer comprises a urethane-acrylate copolymer.

5. A method according to claim 1 wherein the transparent thermoplastic protective layer and the thermoplastic material are formed of the same polymer type.

6. A method according to claim 1 wherein the transparent thermoplastic protective layer is disposed on a release liner before the printing step.

7. A method according to claim 1 wherein the transparent thermoplastic protective layer has a thickness in a range from 10 to 100 micrometers.

8. A method according to claim 1 wherein the transparent thermoplastic protective layer has a thickness in a range from 25 to 50 micrometers.

9. A method according to claim 5 wherein the release liner has a thickness in a range from 50 to 1000 micrometers.

10. A method according to claim 5 wherein the release liner comprises a polyethylene terephthalate film.

11. A method of protecting a graphic substrate comprising:
providing a transparent thermoplastic protective layer;
printing an image onto the transparent thermoplastic protective layer, wherein the image is formed by an ink-jet printer and an organic solvent-based ink comprising organic solvent, a thermoplastic material, and a pigment;
drying off at least a portion of the organic solvent to form an image transfer film article; and
laminating the image transfer film article onto a graphic substrate with heat and pressure, wherein both the transparent thermoplastic protective layer and the thermoplastic material soften and adhere to the graphic substrate to form a protected graphic substrate.

12. A method according to claim 11 wherein the graphic substrate is formed of a polymeric material.

13. A method according to claim 11 wherein the graphic substrate comprises a urethane polymer, an acrylate polymer, a vinyl polymer, or mixtures thereof.

14. A method according to claim 11 wherein the graphic substrate comprises a polyvinylchloride.

15. A method according to claim 11 wherein the thermoplastic material comprises a urethane polymer, an acrylate polymer, a vinyl polymer, or mixtures thereof.

16. A method according to claim 11 wherein the transparent thermoplastic protective layer comprises a urethane polymer, an acrylate polymer, a vinyl polymer, or mixtures thereof.

17. A method according to claim 11 wherein the transparent thermoplastic protective layer and the thermoplastic material are formed of the same polymer type.

19. A method according to claim 11 wherein the release liner is disposed on the transparent thermoplastic protective layer before the printing step.

19. A method according to claim 11 wherein the release liner is removed from the transparent thermoplastic protective layer after the laminating step.
